(19) United States
(12) Patent Application Publication
(10) Pub. No.: US 2014/0006967 A1
(43) Pub. Date: Jan. 2, 2014

(54) CROSS-APPLICATION TRANSFERS OF USER INTERFACE OBJECTS

(71) Applicants: Suresh Arumugam, Los Gatos, CA (US); Benjamin Rottler, San Francisco, CA (US); Pilar Strutin-Belinoff, Oakland, CA (US); Itai Vonshak, Palo Alto, CA (US); Jeremy F. Bennett, San Carlos, CA (US)

(72) Inventors: Suresh Arumugam, Los Gatos, CA (US); Benjamin Rottler, San Francisco, CA (US); Pilar Strutin-Belinoff, Oakland, CA (US); Itai Vonshak, Palo Alto, CA (US); Jeremy F. Bennett, San Carlos, CA (US)

(21) Appl. No.: 13/537,669

(22) Filed: Jun. 29, 2012

(51) Int. Cl. G06F 3/01

(52) U.S. Cl. 715/748; 715/764; 715/769

(57) ABSTRACT

Example embodiments relate to cross-application transfers of user interface (UI) objects. In example embodiments, a user command to provide a UI object from a first application to a second application is received. In response, a data object is created that includes metadata describing the UI object and a reference to code that executes functionality of the UI object. The UI object is then displayed within the second application and the code referenced in the data object is executed to enable the functionality of the UI object within the second application.

### BACKGROUND

A typical user of a computing device relies on a significant number of applications running on the device for both business and personal tasks. For example, a user of a mobile phone, tablet, laptop, or desktop may utilize different applications for writing email, creating documents, browsing the web, listening to music, viewing images, and performing various other functions. The number of applications utilized by a typical user has increased with the advent of easily-accessible online application catalogs that enable instantaneous downloads of applications.

### BRIEF DESCRIPTION OF THE DRAWINGS

The following detailed description references the drawings, wherein:

FIG. 1 is a block diagram of an example computing device for cross-application transfers of user interface objects;

FIG. 2 is a block diagram of an example computing device for transferring user interface objects between a first application and a second application via an operating system of the computing device;

FIG. 3 is a flowchart of an example method for cross-application transfers of user interface objects;

FIG. 4 is a flowchart of an example method for transferring a user interface object between a first application and a second application via an operating system;

FIG. 5A is a diagram of an example user interface in which a user has selected a memo from a memo application;

FIG. 5B is a diagram of an example user interface in which a user has initiated a drag-and-drop command to move a selected memo from a window of a memo application to a window of a sharing application;

FIG. 5C is a diagram of an example user interface in which a user has dropped a selected memo into a window of a sharing application; and

FIG. 5D is a diagram of an example user interface in which a sharing application has displayed a transferred memo and enabled user editing of the memo within the sharing application.

### DETAILED DESCRIPTION

As detailed above, users of computing devices execute applications to accomplish a variety of different functions. In addition, due to the simplicity of downloading and installing applications, users now rely on more applications than ever before. While an application is typically directed to a somewhat narrow purpose, it is important to the user experience that devices allow a user to easily transfer data between applications.

Some existing solutions enable a user to transfer data between applications. For example, most operating systems implement a copy and paste function by which a user may select a data item in one application and subsequently insert a copy of the data item into another application. Furthermore, some operating systems enable the copy and paste function by allowing the user to select an item in one application and then drag it to another application's window.

These existing solutions, however, generally do not allow the functionality of a copied object to transfer with the object. For example, continuing with the copy and paste example, suppose that a user is using an image viewing application that enables zoom and crop functions via direct interaction with the image. Further suppose that the user copies the image and pastes it into a document open in a word processor. In typical copy and paste implementations, the word processor would not enable the user to zoom or crop the image unless the word processor itself natively includes those functions. In other words, the zoom and crop functions would not be transferred with the image object.

Example embodiments disclosed herein address these issues by enabling transfers of user interface (UI) objects between applications in a manner that preserves the functionality of the UI objects. For example, in some embodiments, a computing device receives a command from a user to transfer a UI object currently displayed in a first application to a second application. In response, the device may then create a data object that stores data related to the UI object. The related data stored for the UI object may include metadata describing the UI object and a reference to code that executes functionality of the UI object. In response to receiving the data object, the second application may then display the UI object and execute the code referenced in the data object, thereby enabling the functionality of the UI object within the second application.

In this manner, example embodiments disclosed herein enable a user to share user interface objects between applications while preserving the embedded functionality of the objects. As a result, the user may quickly and easily transfer an object and any embedded functionality from one application to another, even when the receiving application does not natively support the particular object type. Furthermore, example embodiments enable a user to share UI objects with other devices by uploading the user interface object and the corresponding code to a server, such as a web-based server.

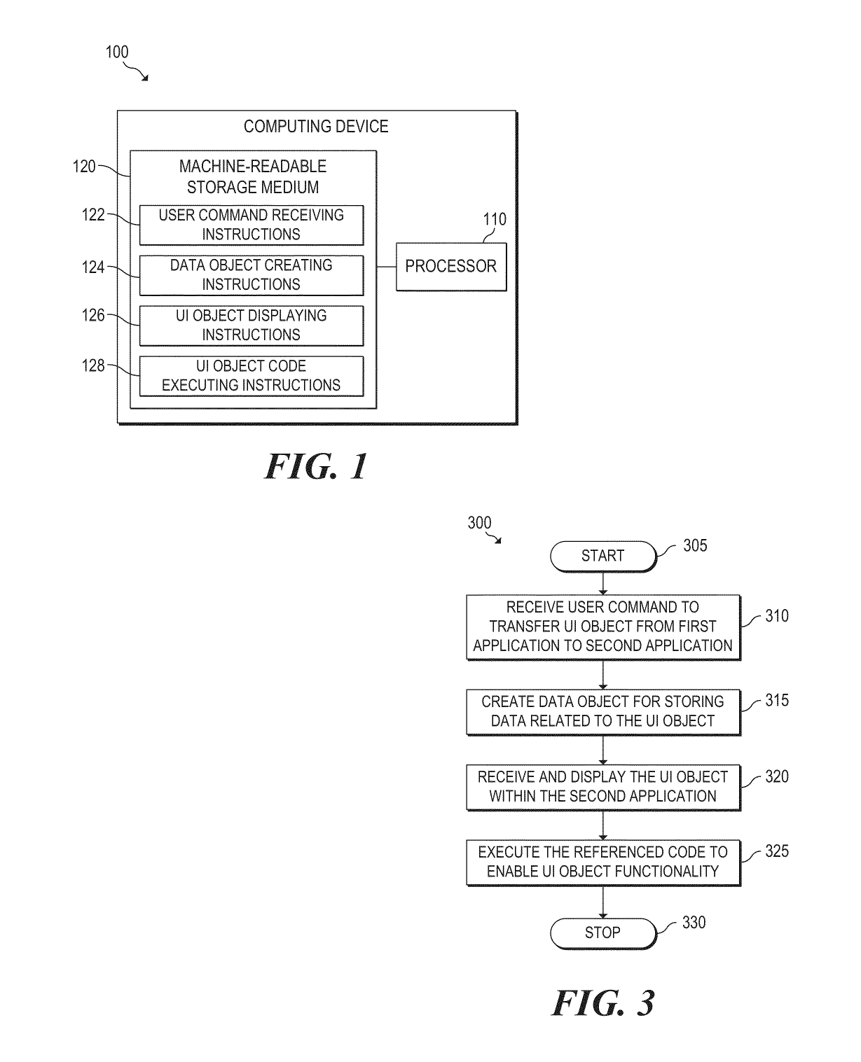

Referring now to the drawings, FIG. 1 is a block diagram of an example computing device 100 for cross-application transfers of user interface objects. Computing device 100 may be, for example, a notebook computer, a desktop computer, an all-in-one system, a tablet computing device, a mobile phone, a set-top box, or any other computing device suitable for displaying a user interface and receiving user input via the user interface. In the embodiment of FIG. 1, computing device 100 includes a processor 110 and a machine-readable storage medium 120.

Processor 110 may be one or more central processing units (CPUs), semiconductor-based microprocessors, and/or other hardware devices suitable for retrieval and execution of instructions stored in machine-readable storage medium 120. Processor 110 may fetch, decode, and execute instructions 122, 124, 126, 128 to transfer UI objects between applications executing within computing device 100. As an alternative or in addition to retrieving and executing instructions, processor 110 may include one or more electronic circuits that include electronic components for performing the functionality of one or more of instructions 122, 124, 126, 128.

Machine-readable storage medium 120 may be any electronic, magnetic, optical, or other non-transitory physical storage device that contains or stores executable instructions. Thus, machine-readable storage medium 120 may be, for example, Random Access Memory (RAM), an Electrically Erasable Programmable Read-Only Memory (EEPROM), a storage device, an optical disc, and the like. As described in detail below, machine-readable storage medium 120 may be encoded with a series of executable instructions 122, 124, 126, 128 for receiving and carrying out a user command to transfer a UI object between applications executing on computing device 100.

User command receiving instructions 122 may initially receive a command to transfer a user interface object currently displayed in a first application to a second application. For example, computing device 100 may be concurrently executing multiple applications and the user may trigger a transfer of a UI object from one application to another by providing input via a touch display, mouse, keyboard, or other input mechanism.

Each of the applications in computing device 100 may comprise instructions executable by processor 110 to enable a user to perform a set of specific tasks. The applications may reside within an operating system (OS) of computing device 100 and call functions provided by the OS to enable the user to perform these tasks. For example, each application may enable the user to communicate with other users, generate or view documents or other files, and/or access data via the Internet or another network. Thus, non-limiting examples of applications for execution in computing device 100 include an email application, messaging application, phone or videoconferencing application, web browser, word processor, contacts application, multimedia viewer, online application catalog, and the like.

In order to enable the user to provide input and receive output via computing device 100, each application may display a number of UI objects with which the user may interact. Each UI object may include a set of visual components outputted on an available display to provide information to a user. For example, the visual components for a given UI object may include visible text, images, UI widgets (e.g., text boxes, scroll bars, selection menus, etc.) or a combination thereof. Furthermore, each UI object may include a corresponding set of functions enabled by one or more portions of executable code. The UI object may execute this code to, for example, receive input from a user, process the input, and modify the visual components of the UI object based on the processed input.

As one set of examples, the UI objects may include discrete visual portions of a given application. For example, when the application is an email application, the UI objects may include individual emails, where each email object is a displayed panel that includes a header with address information and a body of the message. The code associated with the email object may implement corresponding functions for the email message, such as a reply function or forward function. As another example, suppose the application is an image viewing application. In this case, each UI object may be an image displayed in the application, while the code associated with the image object may enable zoom and crop functions. Other suitable examples of UI objects and their corresponding functions will be apparent depending on the particular type of application.

As mentioned above, the user may initialize the transfer of a UI object from one application to another by providing a predetermined command via touch, mouse, voice, or keyed input. As one specific example, the user may utilize a drag and drop operation by clicking or touching the object in the first application, continuing to hold the input while moving a mouse or finger, and releasing the object within the window of the second application. As detailed below, instructions 124, 126, 128 may then manage the process for displaying the UI object in the second application and enabling the associated functionality.

To enable the transfer of the UI object from the first application to the second application, data object creating instructions 124 may create a data object that stores data related to the UI object. For example, the data object may be any data construct that stores metadata describing the UI object and a reference to code that executes functionality of the UI object.

The metadata included in the data object may be any set of data that describes the particular UI object. For example, the metadata may store a unique identifier (UID) that includes a plurality of alphabetic, numeric, and/or symbolic characters. The UI may uniquely identify the particular data object throughout the entire OS of device 100. The metadata may additionally include a data type that specifies the type of UI object (e.g., email, image, video, contact, text message, note, etc.), such that the receiving application can access the type to determine how to display the UI object. Finally, the metadata may include the actual content of the object, such as displayable text, images, UI widgets, or a combination thereof.

As an example, when the application is an email application and the UI object is a particular email, the metadata may include a UID for the particular email, a data type of “email,” and content including the text of the header and email itself. As another example, when the application is an image viewer and the UI object is a given image, the metadata may include a UID for the image, a data type of “image,” and content including encoded data for the image contents. As a third example, when the application is a social networking application and the UI object is a post by a particular person, the metadata may include a UID for the post, a data type of “social networking post,” and corresponding content, such as an image of the posting user, text of the post content, and “likes” and comments created with respect to the post.

As mentioned above, the created data object may also include a reference to the executable code that provides functionality for the particular UI object. The code referenced by the data object may include a predetermined set of functions that enable the user to interact with the UI object, where each function implements a particular action for the UI object. As one example, the reference to the code may include a file path for a storage location on computing device 100 that stores the executable code that provides the functionality for the UI object. As another example, the reference to the code may instead include a copy of the code, such that the data object embeds the entire set of executable code. The format of the code referenced by the data object may vary by embodiment. For example, the code may be code that is executable alone (e.g., Javascript code) or executable code embedded within another document (e.g., Javascript code embedded with an HTML document).

Regardless of the format of the data object and the data included therein, data object creating instructions 124 may create the data object at a point in time prior to the transfer of the UI object to the second application. In some implementations, the first application may create the data object, including the metadata and the code reference, in response to a predetermined command. For example, the first application may create the data object in response to a command in which the UI object is selected with a touch or click and held for a predetermined duration of time. As another example, the first application may create the data object when the user provides a gesture in which the UI object is selected and dragged outside of the window defined by the first application. The first application may thereby preserve resources by delaying creation of the data object until the user provides a command indicating a desire to transfer the UI object to another application.

After data object creating instructions 124 generate the object, including the metadata and code reference, instructions 124 may then provide the data object to the second application. In some implementations, creating instructions 124 may provide the data object to the operating system of computing device 100. In response, the operating system may then forward the data object to the second application.

In response to receipt of the UI object, displaying instructions 126 may display the UI object within the second application. For example, the second application may receive the UI object, access the metadata to determine the type of the data object, and then display the UI object within the user interface of the second application.

In displaying the UI object, displaying instructions 126 may utilize a predetermined display format for the object type based on the metadata included in the data object. For example, displaying instructions 126 may execute a set of instructions (e.g., a predetermined Application Programming Interface (API) function) that receives the object metadata as a parameter and then outputs the object and any associated content. As a specific example, suppose the object type received by displaying instructions 126 is “email.” In response, displaying instructions 126 may execute a predetermined set of instructions for displaying the email by providing the function with the content for the email, such as the addressing information and the message body. Displaying instructions 126 may thereby output the email and any associated metadata within the second application.

After display of the UI object, UI object code executing instructions 128 may then execute the code referenced in the data object to enable the functionality of the UI object within the second application. For example, when the code reference included in the data object is a file path, executing instructions 128 may access the identified file path and execute the code included in that file path. Alternatively, when the code reference included in the data object is a copy of the code itself, executing instructions 128 may simply load the embedded code and begin executing the code.

Continuing with the previous example, suppose the object that was displayed by displaying instructions 126 is an email and that the data object for the email included a reference to a file path including JavaScript code. In response, executing instructions 128 may access the specified file path, retrieve the referenced code in the path, and begin executing the corresponding JavaScript code. In this manner, executing instructions 128 may enable the user to access functionality of the email object within the second application. For example, the underlying JavaScript code could enable the user to send a reply to the message from within the second application.

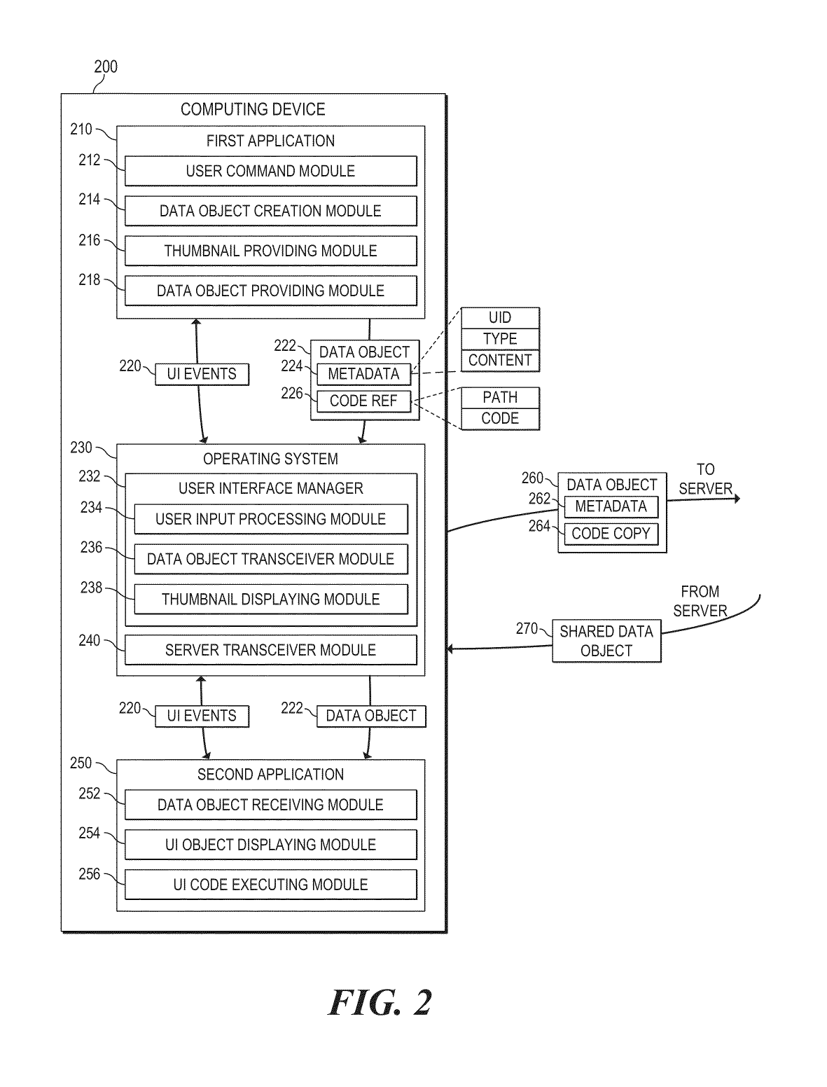

FIG. 2 is a block diagram of an example computing device 200 for transferring user interface objects between a first application 210 and a second application 250 via an operating system 230 of the computing device 200. As with computing device 100 of FIG. 1, computing device 200 may be any computing device suitable for displaying a user interface and receiving user input via the user interface.

As illustrated in FIG. 2 and described in detail below, computing device 200 may include a number of modules 210-256. Each of the modules may include a series of instructions encoded on a machine-readable storage medium and executable by a processor of computing device 200. In addition or as an alternative, each module may include one or more hardware devices including electronic circuitry for implementing the functionality described below.

First application 210 may be any set of instructions executable by a processor of computing device 200 to enable a user to perform a set of tasks. Thus, first application 210 may output a user interface including a number of UI objects with which the user may interact to perform the set of tasks. In the implementation of FIG. 2, first application 210 may include user command module 212, data object creation module 214, thumbnail providing module 216, and data object providing module 218.

User command module 212 may initially receive a user command to transfer a UI object currently displayed by first application 210 to second application 250. For example, user command module 212 may receive a notification of a UI event 220 from UI manager 232 of operating system 230, where the UI event 220 specifies details regarding an input provided by the user (e.g., a touch input, mouse click, etc.). User command module 212 may then determine whether the UI event 220 specifies a user command to initiate a transfer of a particular UI object to another application. For example, user command module 212 may determine whether the user has selected and held a particular UI object for a predetermined duration of time, thereby indicating a desire to begin the process for transferring the UI object to another application. As another example, user command module 212 may determine whether the user has selected and dragged a particular UI object outside of the window of first application 210. Further details regarding the process for detecting user commands are provided above in connection with user command receiving instructions 122 of FIG. 1.

Upon detection of a user command to transfer a particular UI object by user command module 212, data object creation module 214 may then create a data object 222 that maintains data related to the UI object. For example, module 214 may create a set of metadata 224 that includes, for example, a unique identifier for the UI object, a type of the UI object, and content of the UI object. Module 214 may also include a code reference 226 in the data object 222, where the code reference 226 is either a link to a storage location that maintains code for the UI object or a copy of the code itself. In this manner, the transfer of objects and their functionality is easily extensible to new applications, as each application is responsible for creating the data object 222 and selecting the particular functionality that will transfer with the UI object. Further details regarding the process for creating a data object corresponding to a UI object are provided above in connection with data object creating instructions 124 of FIG. 1.

In addition to creation of a data object 222 for the UI object by module 214, thumbnail providing module 216 may also create a thumbnail image to represent the UI object. For example, module 216 may generate an image that contains a reduced size preview of the UI object. The image may be, for example, a Joint Photographics Experts Group (JPEG) image, a Graphics Interchange Format (GIF) image, a Portable Network Graphics (PNG) image, or an image encoded according to any other format. Alternatively, the thumbnail image may include a number of UI components at a reduced size (e.g., reduced size text, images, and UI widgets). After generating the thumbnail image of the UI object, thumbnail providing module 216 may then provide the thumbnail to user interface manager 232 of operating system 230 for display by thumbnail displaying module 238.

After creation of the data object 222 by data object creation module 214, data object providing module 218 may then provide the data object 222 to operating system 230. For example, data object providing module 218 may provide the data object 222, including metadata 224 and code reference 226, to user interface manager 232 of operating system 230.

Operating system 230 may be any set of instructions executable by a processor of computing device 200 to manage the hardware resources of computing device 200 and provide an interface to the hardware to applications running in OS 230, such as first application 210 and second application 250. In the implementation of FIG. 2, operating system 230 may include user interface manager 232 and server transceiver module 240.

User interface manager 232 may be a component of operating system 230 that manages the user interfaces presented by applications 210, 250. For example, user interface manager 232 may provide a set of user interface features accessible by applications 210, 250 using API function calls. User interface manager 232 may also provide an application runtime environment, such that user interface manager 232 loads applications 210, 250 and manages their scheduling and execution. In the implementation of FIG. 2, user interface manager 232 includes user input processing module 234, data object transceiver module 236, and thumbnail displaying module 238.

User input processing module 234 may receive notifications of user input events from operating system 230 and, in response, provide UI event notifications 220 to applications 210, 250. For example, user input processing module 234 may provide notifications of UI events 220 that describe a type of input (e.g., touch or mouse input), the location of the input (e.g., coordinates on a display of device 200), and any other descriptors of the input (e.g., a duration of a hold of the input). As detailed above, user command module 212 of first application 210 may then process the event notifications 220 to determine whether the user has provided a command to transfer a UI object to second application 250. Alternatively, user input processing module 234 may process the input from the user with reference to the displayed UI objects and directly notify the applications 210, 250 when the user has provided a command to initialize or complete a transfer of a UI object.

Data object transceiver module 236 may manage the process for receiving and transmitting data objects 222 between applications 210, 250. After first application 210 has created an object 222, data object transceiver module 236 may receive the data object 222 from first application 210. Then, after identifying the second application 250 that will receive the object 222, data object transceiver module 236 may pass the data object 222 to the second application 250. Transceiver module 236 may similarly pass the object to other applications executing in operating system 230, such that the user may transfer UI objects to multiple applications. In this manner, data object transceiver module 236 may serve as an operating system intermediary between first application 210 and any other applications that desire to receive the data object, such as second application 250.

In addition to managing the process for transferring the data object 222 between applications, UI manager 232 may also manage the visualization of the object during the transfer from first application 210 to second application 250. For example, thumbnail displaying module 238 may initially receive the thumbnail image of the UI object to be transferred from thumbnail providing module 216 of first application 210. Thumbnail displaying module 238 may then display the thumbnail image of the UI object while the UI object is dragged from the window of first application 210 to the window of second application 250.

Server transceiver module 240 may manage the process for uploading a data object 260 to a server in response to a user command to share a particular UI object with another user or device. For example, first application 210 or second application 250 may include a user interface element that enables a user to share UI objects with other users (e.g., a button labeled “Share”). By selecting the interface element, the user may trigger an operation by which one or more UI objects in the application 210, 250 are uploaded to a server, which may be a web-based server.

In response, server transceiver module 240 may generate a copy of each data object 260 that includes the metadata 262 and a copy of the code 264. Thus, when the code reference 226 in the original data object 222 is a file path or other storage location, server transceiver module 240 may initially retrieve the code from the location and insert a copy of the code 264 into the data object 260. Transceiver module 240 may then upload a copy of the data object 260, including metadata 262 and code copy 264, to a predetermined location on a server. Other computing devices 200 may subsequently output the shared object 260 by receiving a copy of the data object 260 from the server and triggering modules 252, 254, 256 to receive the UI object, display the object, and execute the corresponding code.

As with first application 210, second application 250 may be any set of instructions executable by a processor of computing device 200 to enable a user to perform a set of specific tasks. In the implementation of FIG. 2, second application 250 may include data object receiving module 252, UI object displaying module 254, and UI code executing module 256.

Data object receiving module 252 may initially receive a data object 222 from UI manager 232 of operating system 230, where the data object 222 was provided to UI manager 232 by first application 210. Alternatively, receiving module 252 may receive the data object 222 from server transceiver module 240 in response to receipt of a shared object 270 from a server.

In response to receipt of data object 222 from operating system 230, UI object displaying module 254 may then output the corresponding UI object within a window of second application 250. For example, UI object displaying module 254 may determine the type of the UI object as specified in data object 222 and output the content of the UI object based on the determined type. Further details regarding the process for displaying a UI object are provided above in connection with UI object displaying instructions 126 of FIG. 1.

Finally, UI code executing module 256 may execute the code referenced in data object 222 to enable the functionality of the UI object within second application 250. For example, when the code reference 226 is a file path or other storage location, code executing module 256 may retrieve the code from the specified storage location, load the code, and begin executing the code. Alternatively, when the code reference 226 is itself a copy of the code, code executing module 256 may retrieve the code from data object 222, load the code, and begin executing the code. In some implementations, second application 250 may rely on UI manager 232 or another component of operating system 230 to interpret and execute the code. For example, when the code is JavaScript or HTML including embedded JavaScript, code executing module 256 may provide the code to operating system 230, which may in turn interpret and execute the code within a window of the second application 250. Further details regarding the process for executing code of a UI object are provided above in connection with code executing instructions 128 of FIG. 1.

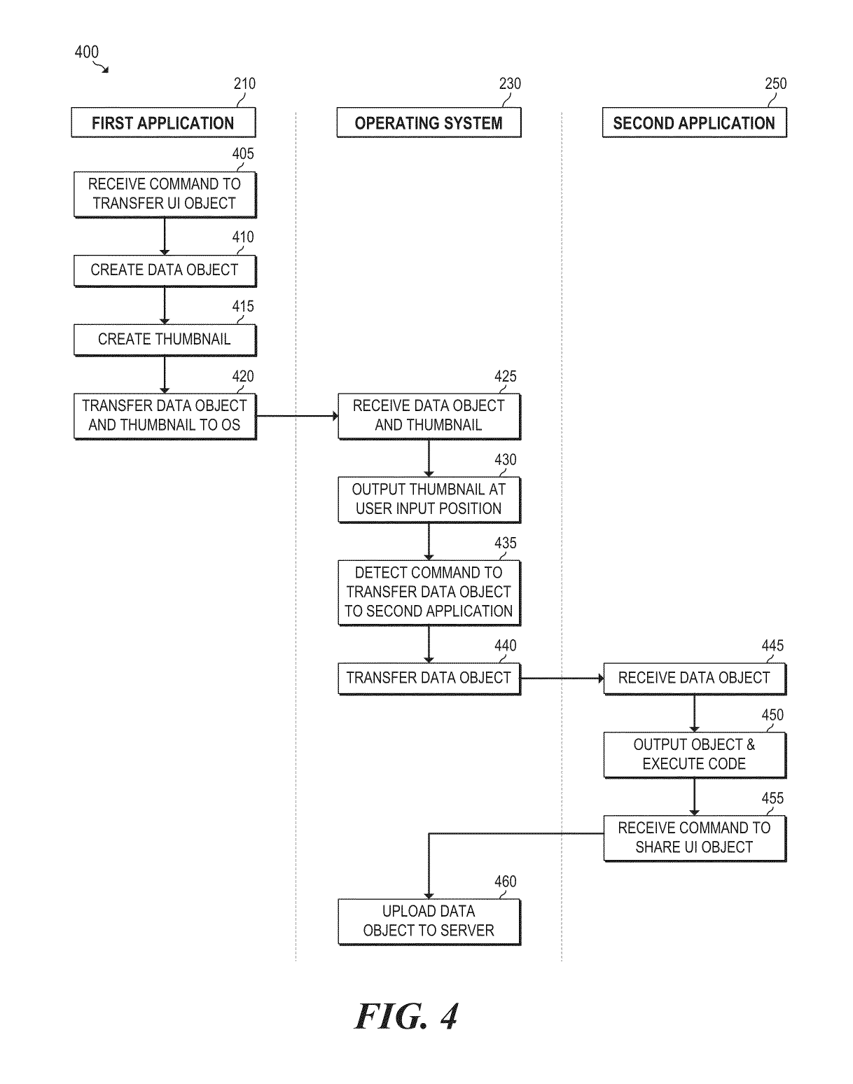

FIG. 3 is a flowchart of an example method 300 for cross-application transfers of user interface objects. Although execution of method 300 is described below with reference to computing device 100 of FIG. 1, other suitable devices for execution of method 300 will be apparent to those of skill in the art (e.g., computing device 200). Method 300 may be implemented in the form of executable instructions stored on a machine-readable storage medium, such as storage medium 120, and/or in the form of electronic circuitry.

Method 300 may start in block 305 and proceed to block 310, where computing device 100 may receive a user command to transfer a UI object currently displayed in a first application to a second application. For example, the user may select a particular UI object in the first application, drag the selected object from the window of the first application, and drop the object within the window of the second application.

In block 315, computing device 100 may then create a data object for storing data related to the UI object to be transferred. For example, computing device 100 may create a data structure for storing metadata related to the UI object, which may include a unique identifier, an object type, and content for the object. The data object generated by computing device 100 may also include a reference to code that executes functionality of the UI object, which may be a file path that includes the code or a copy of the code itself. In some implementations, block 315 may be implemented by the first application and, in response to creating the data object, the first application may then forward the data object to the operating system of computing device 100.

Next, in block 320, the second application may receive the data object created in block 315. For example, the second application may receive the data object from the operating system and, in response, extract the metadata and reference to the code. The second application may then display the UI object within the second application by, for example, determining the type of the UI object and displaying the UI object based on the type.

Finally, in block 325, the second application may execute the code referenced in the data object to enable the functionality of the UI object within the second application. For example, when the code reference is a file path, the second application may access the identified file path and execute the code included in that path. As another example, when the code reference in the data object is the code itself, the second application may simply load the included code and begin execution of the code. Method 300 may then proceed to block 330, where method 300 may stop.

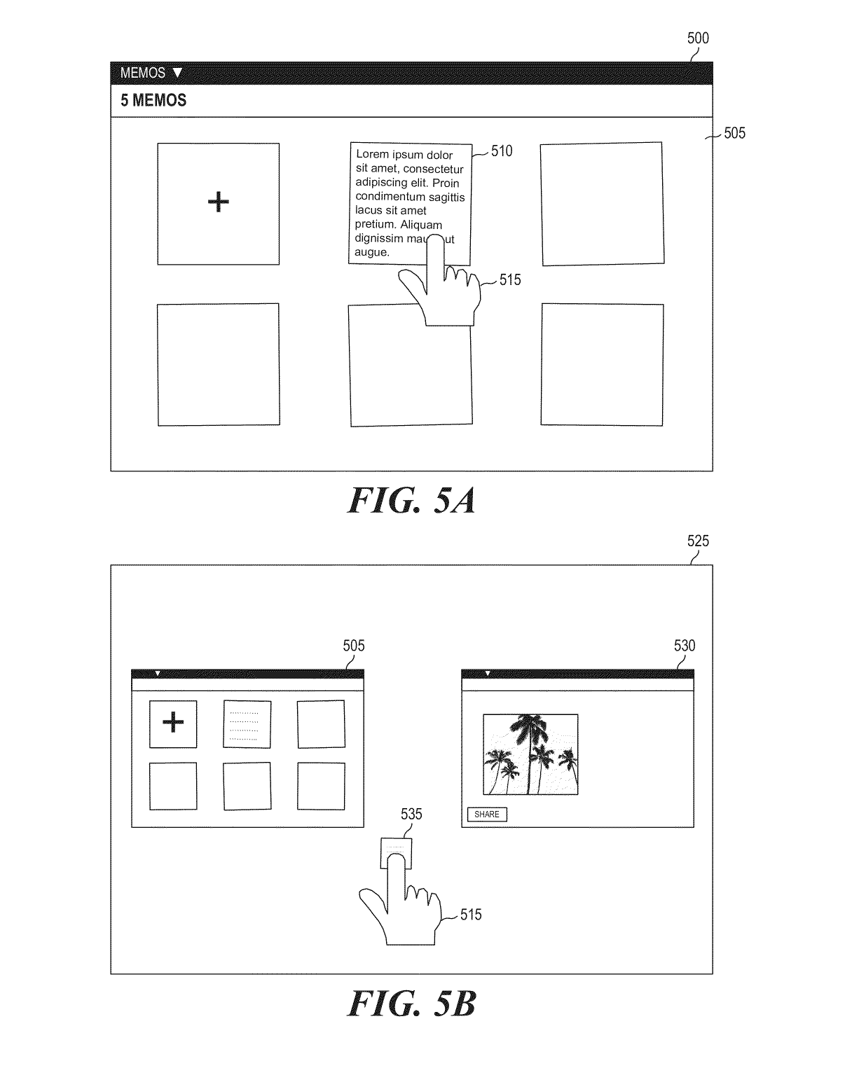

FIG. 4 is a flowchart of an example method 400 for transferring a user interface object between a first application and a second application via an operating system. Although execution of method 400 is described below with reference to components 210, 230, 250 of computing device 200 of FIG. 2, other suitable components for execution of method 400 will be apparent to those of skill in the art. Method 400 may be implemented in the form of executable instructions stored on a machine-readable storage medium and/or in the form of electronic circuitry.

As illustrated, method 400 may include a number of blocks 405, 410, 415, 420 executed by first application 210, a number of blocks 425, 430, 435, 440, 460 executed by operating system 230, and a number of blocks 445, 450, 455 executed by second application 250. Note that, in some implementations, execution of the blocks of method 400 may be distributed differently between first application 210, operating system 230, and second application 250.

Method 400 may start in block 405, where first application 210 may receive a command to transfer a UI object to a second application. For example, first application 210 may receive a touch input or mouse input that indicates a desire to transfer a particular UI object to another application. This input may be, for example, a held selection of the particular UI object for a given period of time or a selection coupled with a drag of the UI object outside of the window of first application 210.

Next, in block 410, first application 210 may create a data object that stores data related to the UI object. For example, first application 210 may create a data structure that stores metadata describing the UI object and a reference to code that executes functionality of the UI object. In block 415, first application 210 may then create a thumbnail image that stores a preview of the content of the UI object to be transferred to the second application. After creating the UI object and thumbnail, first application may then, in block 420, transmit the data object and thumbnail to operating system 230.

Execution of method 400 may then transfer to operating system 230 when, in block 425, operating system 230 may receive the data object and thumbnail generated by first application 210. Operating system 230 may then store the data object and thumbnail in a machine-readable storage medium of computing device 200, which may be, for example, Random Access Memory (RAM). In block 430, operating system 230 may then output the thumbnail image of the UI object at the position of the user's input. For example, as the user drags the UI object around the visible display area of computing device 200, UI manager 232 of operating system 230 may track the position of the user's input with the thumbnail.

In block 435, operating system 230 may then detect a command to transfer the UI object to another application executing within operating system 230, such as second application 250. For example, UI manager 232 of operating system 230 may determine that the user has released the dragged UI object and, in response, determine whether the position of the released input falls within the window of an application. If so, in block 440, operating system 230 may transfer the data object generated for the UI object to the corresponding application, which is the second application 250 in this case.

In block 445, second application 250 may receive the data object from operating system 230, including the metadata and the reference to the code. Next, in block 450, second application 250 may output the UI object corresponding to the data object and execute the referenced code. For example, second application 250 may identify the type of the UI object using the metadata and output the UI object based on the object type. As one example, second application 250 may call an API function for the object type that receives parameters of the UI object (e.g., content data) and, in response, outputs the object within second application 250. In addition, in block 450, second application 250 may execute the code referenced in the data object by retrieving the code from the storage location specified in the code reference or, alternatively, directly from the data object. Second application 250 or a component of operating system 230 may then interpret and execute the code, thereby enabling the functionality of the UI object within second application 250.

In block 455, second application 250 may subsequently receive a command to share the displayed UI object with another computing device. For example, second application 250 may be an environment for sharing a plurality of UI objects with other devices and may include a single user interface element that triggers a synchronization of the entire environment (e.g., a button labeled “Share”). In such implementations, second application 250 may trigger an upload of every UI object in response to a user's activation of the user interface element. Alternatively, second application 250 may receive commands to synchronize UI objects individually and may instead trigger an upload of one UI object at a time. Regardless of the implementation, second application 250 may provide a command to operating system 230 to upload each object to a predetermined location on a server, such as a web server.

In response to a command to upload one or more UI objects to a server, operating system 230 may then trigger each upload in block 460. For example, operating system 230 may transmit the data object corresponding to each UI object to a server at a predetermined location. Each transmitted data object may include the metadata and a copy of the referenced code. In this manner, the server may share the UI objects with other devices by simply transmitting the data objects to the other devices.

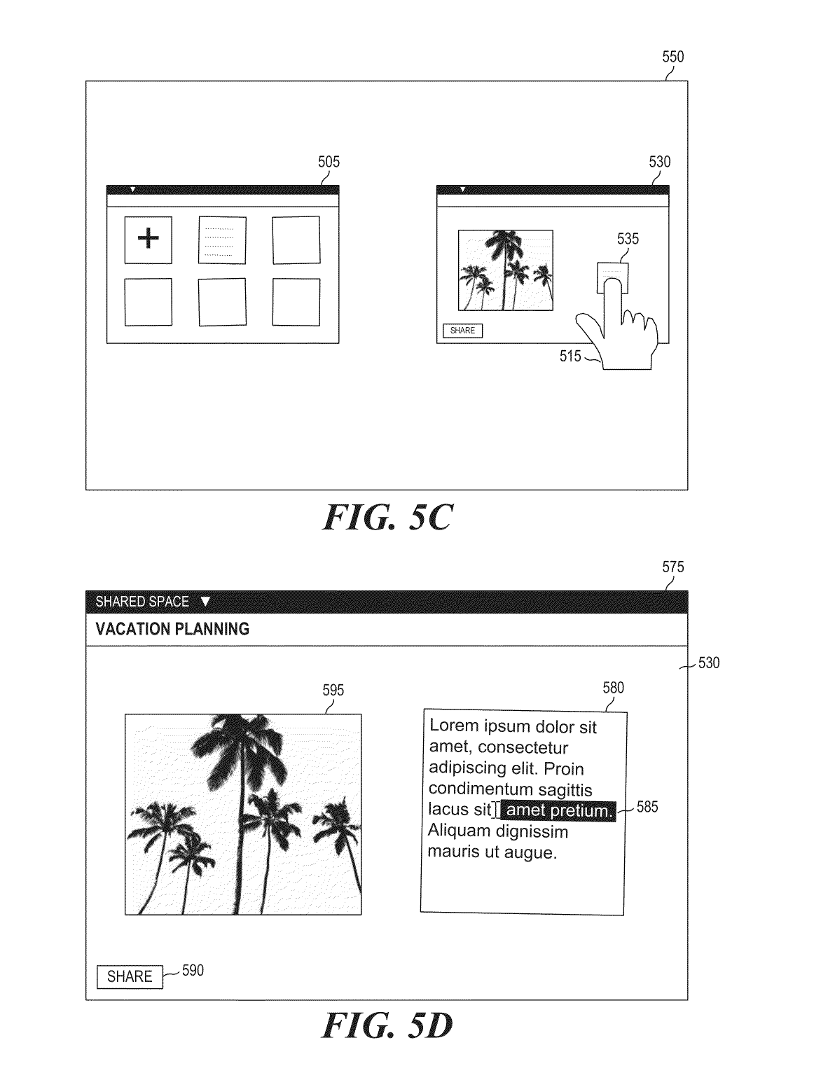

FIG. 5A is a diagram of an example user interface 500 in which a user has selected a memo 510 from a memo application 505. As illustrated, user interface 500 includes an interface displayed by a memo application 505 that enables a user to create and edit memos. As represented by hand 515, the user has activated a touch input on top of one of the five memos, memo 510, and held the touch input on memo 510 for a predetermined duration of time.

In response to the touch-and-hold input, the memo application may then create a data object that stores data related to the selected UI object, memo 510. For example, as detailed above, the memo application may create a data object that stores metadata for the object (e.g., a unique identifier, a type of “memo”, and the text of the memo) and code that enables functionality for the memo 510, such as a text edit function. The memo application may also create a thumbnail image that captures a preview image of memo 510. After creating the data object for memo 510 and the thumbnail of memo 510, the computing device may then forward the data object and thumbnail to an operating system of the computing device.

FIG. 5B is a diagram of an example user interface 525 in which a user has initiated a drag-and-drop command to move a selected memo 510 from a window of a memo application 505 to a window of a sharing application 530. As detailed above, in response to the user's selection of memo 510 in FIG. 5A, memo application 505 has provided a corresponding data object and thumbnail 535 to the operating system of the device. In response, as illustrated in FIG. 5B, the operating system has modified the user interface 525 to display the memo application 505 and a sharing application 530 in a windowed mode. The operating system has also outputted the thumbnail 535 at the position of the user's input.

FIG. 5C is a diagram of an example user interface 550 in which a user has dropped a selected memo 510 into a window of a sharing application 530. As illustrated, the user has dragged the thumbnail 535 of memo 510 into the window of sharing application 530 and released the held touch gesture. In response, the operating system may then forward the data object created by memo application 505 to the sharing application 530, such that sharing application 530 receives the metadata and code reference for memo 510.

FIG. 5D is a diagram of an example user interface 575 in which a sharing application 530 has displayed a transferred memo 580 and enabled user editing of the memo 580 within the sharing application 530. In response to receipt of the data object for memo 510, sharing application 530 may then access the corresponding metadata to determine the type of the object (“memo” in this case) and output the memo 580 within its user interface. In addition, sharing application 530 may execute the code referenced in the data object received from the operating system, such that the functionality of memo 510 is enabled in sharing application 530. Thus, as illustrated, memo 580 has preserved its editing functionality, as illustrated by the text 585 selected for editing.

As illustrated, sharing application 530 also includes a sharing user interface element 590, labeled “Share.” In response to activation of the sharing UI element 590, sharing application 530 may upload all UI objects included in the environment to a server at a predetermined location, such as a location on a cloud server associated with the particular user of the computing device. More specifically, sharing application 530 may provide a data object corresponding to each UI object to the operating system of the device, along with a command to upload the device to the server. Thus, sharing application 530 may provide the data object for the memo 580 and a data object for the displayed image 595 to the operating system, which may in turn upload the data objects to a server.

The foregoing disclosure describes a number of example embodiments for enabling a user to transfer a user interface object between applications, while preserving the functionality of the object. Thus, an application may receive an object from another application and execute the functionality associated with the object, even when the application does not natively support the particular object type. Further embodiments enable sharing of UI objects between devices by uploading data objects to a server, such that the UI objects and their embedded functionality may be transferred between devices. Additional embodiments and advantages of such embodiments will be apparent to those of skill in the art upon reading and understanding the foregoing description.

We claim:

1. A computing device for cross-application transfers of user interface (UI) objects, the computing device comprising:
a processor to:
receive a user command to transfer a UI object currently displayed in a first application to a second application,
create a data object that stores data related to the UI object, the related data including metadata describing the UI object and a reference to code that executes functionality of the UI object,
display the UI object within the second application in response to receipt of the data object by the second application, and
execute the code referenced in the data object to enable the functionality of the UI object within the second application.

2. The computing device of claim 1, wherein the user command to transfer the UI object is a drag and drop command by which the UI object is moved from a window of the first application to a window of the second application.

3. The computing device of claim 2, wherein the processor is further configured to:
display a thumbnail image of the UI object while the UI object is dragged from the window of the first application to the window of the second application.

4. The computing device of claim 1, wherein the processor is configured to create the data object in response to one of:
a command in which the UI object is selected and held for a predetermined duration, and
a gesture in which the UI object is selected and dragged outside of the window of the first application.

5. The computing device of claim 1, wherein:
the first application creates the data object in response to the user command to transfer the UI object,
the first application provides the data object to a UI manager executing within an operating system (OS) of the computing device, and
the UI manager passes the data object to the second application.

6. The computing device of claim 1, wherein the metadata comprises a unique identifier for the data object, a type of the UI object, and data describing content of the UI object.

7. The computing device of claim 6, wherein the data describing content of the UI object comprises information created with respect to the UI object in a social network.

8. The computing device of claim 1, wherein the code referenced by the data object includes a predetermined set of functions that enable UI interactions for the UI object.

9. The computing device of claim 1, wherein the reference to the code is one of:
a file path for a location on the computing device that stores executable code, and
executable code embedded within the data object.

10. The computing device of claim 1, wherein the processor is further configured to upload the metadata and a copy of the referenced code to a server in response to a user command to share the UI object.

11. A machine-readable storage medium encoded with instructions executable by a processor of a computing device for cross-application transfers of UI objects, the machine-readable storage medium comprising:
instructions for receiving a command to share a UI object currently displayed in a first application with a second application;
instructions for creating a data object including metadata describing the UI object and a reference to code that executes functionality of the UI object;
instructions for displaying the UI object within the second application in response to receipt of the data object by the second application;
instructing for executing the code referenced in the data object to enable the functionality of the UI object within the second application; and
instructions for uploading the metadata and a copy of the referenced code to a server subsequent to receipt of the data object in the second application.

12. The machine-readable storage medium of claim 11, wherein the instructions for creating the data object are triggered in response to one of:
a command in which the UI object is selected and held for a predetermined duration, and
a gesture in which the UI object is selected and dragged outside of the window of the first application.

13. The machine-readable storage medium of claim 11, further comprising instructions for a UI manager of an operating system of the computing device to receive the data object from the first application and forward the data object to the second application.

14. A method for execution by a computing device for cross-application transfers of UI objects, the method comprising:
receiving, by the computing device, a user command to provide a UI object currently displayed in a first application to a second application;
creating, by the first application, a data object including metadata describing the UI object and a reference to code that executes functionality of the UI object;
providing the data object from the first application to an operating system of the computing device;
transferring the data object from the operating system to the second application;
displaying the UI object within the second application; and
executing the code referenced in the data object to enable the functionality of the UI object within the second application.

15. The method of claim 14, further comprising:
uploading the metadata and a copy of the referenced code to a server in response to a user command to share the UI object with another user.
